(19) United States
(12) Patent Application Publication
(10) Pub. No.: US 2004/0191605 A1
(43) Pub. Date: Sep. 30, 2004

(54) Gas diffusion layer containing inherently conductive polymer for fuel cells

(75) Inventors: Mark R. Kinkelaar, Glenmoore, PA (US); Gennadi Finkelshtain, Shoham (IL)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Foamex L.P.

(21) Appl. No.: 10/744,133

(22) Filed: Dec. 24, 2003

Related U.S. Application Data
(60) Provisional application No. 60/436,459, filed on Dec. 27, 2002.

(51) Int. Cl. H01M 2/14; H01M 4/86; H01M 4/90; H01M 4/96

(52) U.S. Cl. 429/38; 429/40; 429/41; 429/44; 429/39

(57) ABSTRACT

A gas diffusion layer comprises a porous material and an electrically conductive material coating at least a portion of an external surface of the porous material, wherein the electrically conductive material comprises at least one inherently conductive polymer. When placed adjacent to or in contact with a cathode of a polymer electrolyte or proton exchange membrane (PEM) fuel cell, the gas diffusion layer helps deliver oxygen to the cathode. The gas diffusion layer may be placed adjacent to or in contact with an anode of a PEM fuel cell to help deliver hydrogen to the anode.

This application claims the benefit of U.S. Provisional Patent Application No. 60/436,459, filed Dec. 27, 2002, the disclosure of which is incorporated by reference in its entirety.

This invention relates to a gas diffusion layer containing at least one inherently conductive polymer suitable to be placed adjacent to a cathode of a polymer electrolyte or proton exchange membrane (PEM) fuel cell to help deliver oxygen to the cathode and/or a gas diffusion layer suitable to be placed adjacent to an anode of the PEM fuel cell to help deliver hydrogen to the anode.

### BACKGROUND OF THE INVENTION

In PEM fuel cells, positive ions within the proton exchange membrane are mobile and free to carry positive charge through the membrane. Movement of hydrogen ions (H⁺) through the membrane from the anode to the cathode is essential to PEM fuel cell operation. The hydrogen ions (H⁺) pass through the membrane and combine with oxygen and electrons on the cathode side producing water. Electrons (e⁻) cannot pass through the membrane. Therefore, electrons collected at the anode flow through an external circuit to the cathode, driving an electric load that consumes the power generated by the fuel cell. The open circuit voltage from a single cell is about 1 to 1.2 volts. Several PEM fuel cells can be stacked in series to obtain greater voltage and membrane area can be increased to get more amperage

In PEM fuel cells, an oxidation half-reaction occurs at the anode, and a reduction half-reaction occurs at the cathode. In the oxidation half-reaction, gaseous hydrogen produces hydrogen ions and electrons at the anode, the flows of which are as described above. In the reduction half-reaction, oxygen supplied from air flowing past the cathode combines with the hydrogen ions that have passed through the proton exchange membrane and electrons to form water and excess heat. Catalysts, such as platinum, are used on both the anode and cathode to increase the rates of each half-reaction. The final products of the overall cell reaction are electric power, water and heat. The fuel cell is cooled, usually to about 80° C. At this temperature, the water produced at the cathode is in both a liquid form and vapor form. The water in the vapor form is carried out of the fuel cell by air flow through a gas diffusion layer and flow fields or channels in a bipolar plate.

A typical PEM fuel cell structure 1 in the prior art is shown in FIG. 1 in exploded view. The membrane electrode assembly (“MEA”) 4 is comprised of a PEM 6 with an anode layer 5 adjacent one surface and a cathode layer 5A adjacent an opposite surface. Gas diffusion layers 3, 3A are positioned adjacent each electrode layer. Bipolar plates 2, 2A are positioned adjacent gas diffusion layer 3, 3A, respectively. The bipolar plates generally are fabricated of a conductive material and have channels (or flow fields) 7 through which reactants and reaction by-products may flow. The adjacent layers of the fuel cell structure contact one another, but in FIG. 1 the adjacent layers are shown separated from one another in exploded view for ease of understanding and explanation.

The polymer electrolyte or proton exchange membrane (PEM) is a solid, organic polymer, usually polyperfluorosulfonic acid, that comprises the inner core of the membrane electrode assembly (MEA). Commercially available polyperfluorosulfonic acids for use as PEMs are sold by E.I. DuPont de Nemours & Company under the trademark NAFION®. Alternative PEM structures are composites of porous polymeric membranes impregnated with perfluoro ion exchange polymers, such as offered by W. L. Gore & Associates, Inc. The PEM must be hydrated to function properly as a proton exchange membrane and as an electrolyte.

A substantial amount of water is liberated at the cathode and must be removed so as to prevent flooding the cathode or blocking the gas flow channels in the bipolar plate, such a flood or blockade can cut off the oxygen supply and locally halt the reaction. In prior art fuel cells, air flows past the cathode to carry all the water present at the cathode as vapor out of the fuel cell.

Prior art fuel cells incorporated porous carbon papers or cloths as gas diffusion layers or backing layers adjacent the PEM of the MEA. The porous carbon materials not only helped to diffuse reactant gases to the electrode catalyst sites, but also assisted in water management. Porous carbon paper was selected because carbon conducts the electrons exiting the anode and entering the cathode. However, porous carbon paper has several disadvantages. First, porous carbon paper has not been found to be an effective material for directing excess water away from the cathode, and often a hydrophobic layer is added to the carbon paper to help with water removal. Second, porous carbon papers have limited flexibility, and tend to fail catastrophically when bent or dropped. Third, porous carbon papers cannot be supplied in a roll form, and, therefore, are less amenable to automated fabrication and assembly. They tend to be rigid and non-conforming, and are not compressible. Careful tolerances are required to maintain an intimate electrical contact between the MEA and the bipolar plate via the carbon paper. The preparation of carbon papers tends to create environmental polution. Finally, porous carbon papers are expensive. Consequently, the fuel cell industry continues to seek replacements of porous carbon papers as gas diffusion layers that will improve fuel delivery and by-product recovery and removal, maintain effective gas diffusion and effective conductive contact, and simplify the manufacturing of fuel cells without adversely impacting fuel cell performance or adding significant weight or expense.

WO 01/15253 discloses a fuel cell containing an electrode comprising a catalytic polymer film prepared from one or more highly inherently conductive polymers with a plurality of transition metal atoms covalently bonded thereto, which film is bonded to the surface of an electrically conducting sheet, such as carbon paper or carbon cloth. However, the above-noted drawbacks associated with carbon paper or cloth are also found with this approach.

Prior art bipolar plates serve at least four functions in fuel cells. First, bipolar plates deliver reactants (pure hydrogen or hydrogen gas mixtures) to the gas diffusion layer and ultimately over the surface of the anode. Second, bipolar plates distribute oxygen, air or other oxidant gases to the gas diffusion layer and ultimately over the surface of the cathode, so bipolar plates of the prior art usually has grooves on the surface to help distribute the oxygen, air or other oxidant gases. Third, when fuel cells are stacked together, the bipolar plates collect and conduct electrons from the anode of one cell to the cathode of an adjacent cell. Fourth, the bipolar plates separate the reactants from any cooling fluids that may be used to cool the fuel cell.

To prevent the mixing of the hydrogen or hydrogen gas mixtures with oxygen, air or other oxidant gases, bipolar plates must be made of a gas-impermeable material in order to separate the gaseous reactants of the anode and the adjacent cathode. Without effective separation by the bipolar plates, direct oxidation/reduction of the gaseous reactants of the anode and adjacent cathode would take place leading to inefficiency. Because the bipolar plates must conduct the electrons produced by the fuel cell reaction in a fuel cell stack, the material used to make the bipolar plates must be inherently conductive. Bipolar plates commonly are formed from machined graphite sheet, carbon-carbon composites, metals such as titanium and stainless steel, or gold-plated metals. Bipolar plates thus can contribute a significant weight to the fuel cell, which is a disadvantage particularly where the fuel cell is intended to be used in portable or transportation applications. Moreover, fabricating the bipolar plates from carbon-carbon composites or machined graphite sheets is expensive. Molded plates frequently have lower conductivity than machined plates. Carbon-based bipolar plates often have higher than desired porosity, which can lead to cross-contamination, so greater plate thicknesses are required. When the bipolar plates are fabricated from metals, the plates may be thinner than carbon-based bipolar plates due to minimal, if any, porosity of metals. However, metals tend to add greater weight and must be carefully selected because the metallic bipolar plates must not corrode or degrade in the fuel cell environment.

Prior art bipolar plates of foamed metals, such as foamed titanium, have several additional drawbacks. First, they are expensive to fabricate. Second, foamed metals with fine pore sizes are difficult to manufacture with known techniques. Third, the metal foams are rigid, and thus can be easily permanently bent or dented, making it difficult to maintain contact with the electrode layers of the MEA and/or the metal separator sheet. Fuel cells containing bipolar plates made with metal foams may require higher clamping pressure to maintain intimate contact. Fourth, as the foamed metals are cut to the desired size, sharp corners are formed, significantly increasing the risk that the MEA will be punctured during assembly. Fifth, having grooves on the surface of the bipolar plate reduces the surface area that can make contact with the gas diffusion layer or electrode, so the assembly of the fuel cell has to be done carefully to ensure that the bipolar plate makes intimate contact with the gas diffusion layer or electrode.

One proposed fuel cell design constructs the bipolar plates with a combination of (a) a gas diffusion layer formed by perforated or foamed metal, and (b) metal separator sheets. The reactants flow through pores of the foamed metal or through slits formed in the perforated metal. The foamed metal has sponge-like structure with small voids or pores that take up more than 50% of the bulk volume of the material. The bipolar plate is formed from two pieces of foamed metal with a thin layer of solid metal in between (separator sheet). The fuel cell stack is formed from layers of (i) metal sheet functioning as a bipolar plate, (ii) foamed metal functioning as a gas diffusion layer, (iii) MEA, (iv) foamed metal functioning as a gas diffusion layer, (v) metal sheet functioning as a bipolar plate, (vi) foamed metal, (vii) MEA, (viii) foamed metal, (ix) metal sheet, . . . etc. J. Larminie and A. Dicks, Fuel Cell Systems Explained, (Wiley & Sons, England 2000), Chap. 4, p. 86. See also, U.S. Pat. No. 4,125,676.

Consequently, the fuel cell industry continues to seek improved fuel cell structures, particularly improved gas diffusion layers that will maintain effective gas diffusion and maintain effective current conductivity without adversely impacting fuel cell performance or adding significant thickness, weight or expense. The present invention is aimed at solving some of the problems associated with prior art gas diffusion layers and bipolar plates mentioned above by providing improved gas diffusion layers, which have the added advantage of simplifying the structural requirements of bipolar plates (for instance, the bipolar plates need not have surface grooves).

### SUMMARY OF THE INVENTION

The first aspect of the invention provides a gas diffusion layer for a fuel cell, the gas diffusion layer comprising a porous material and at least one electrically conductive material, wherein the porous material comprises a solid matrix and interconnected pores or interstices therethrough, at least one external surface and internal surfaces, wherein at least a portion of the at least one external surface is coated with one or more layers of the at least one electrically conductive material. The “internal surfaces” of the porous material are the surfaces of the walls of the pores or interstices. As used herein, the term “electrically conductive material” means a material comprising at least one inherently conductive polymer, and optionally also at least one electrically conductive substance, e.g. electrically conductive carbon, other than the at least one inherently conductive polymer. As used herein, the term “inherently conductive polymer” means a polymer that can conduct electricity itself, doped or not doped, but without the addition of another electrically conductive substance such as a metal or electrically conductive carbon.

In the porous material of the gas diffusion layer of the present invention, preferably, at least portions of at least some of the internal surfaces are coated with one or more layers of at least one electrically conductive material in addition to the at least a portion of the at least one external surface being coated with at least one electrically conductive material, wherein the coated portions of the internal surfaces and the coated portion of the at least one external surface together forms an electrically conductive pathway. The at least one electrically conductive material coating the at least portions of at least some of the internal surfaces may be the same as (preferred) or different from the at least one electrically conductive material coating the at least a portion of the at least one external surface.

If the porous material of the gas diffusion layer of the invention has two or more external surfaces, e.g. at least first and second external surfaces, it is also preferred that at least a portion of the first external surface and at least a portion of the second external surface are coated with one or more layers of at least one electrically conductive material, with the coated portions of the first and second external surfaces together forming an electrically conductive pathway. The at least one electrically conductive material coating the at least a portion of the first external surface may be the same as (preferred) or different from the at least one electrically conductive material coating the at least a portion of the second external surface. More preferably, in addition to at least portions of the first and second external surfaces being coated with at least one electrically conductive material, at least portions of some of the internal surfaces of the porous material are coated with one or more layers of at least one electrically conductive material, with the coated portions of the first and second external surfaces, as well as the coated portions of some of the internal surfaces, together forming an electrically conductive pathway. The at least one electrically conductive material coating the at least portions of some of the internal surfaces, the at least one electrically conductive material coating the at least a portion of the first external surface and the at least one electrically conductive material coating the at least a portion of the second external surface may be the same (preferred) or different.

The gas diffusion layer of the present invention can be in the shape of a substantially rectangular or square sheet having six external surfaces: first and second major external surfaces opposite to each other and first, second, third and fourth minor external surfaces, wherein at least a portion of at least one of the major external surfaces is coated with one or more layers of at least one electrically conductive material. The first and third minor external surfaces are opposite to each other. The second minor external surface is opposite the fourth minor external surface. Preferably, at least a portion of at least the first major external surface and at least a portion of at least the first minor external surface are coated with one or more layers of at least one electrically conductive material, with the coated portion of the first major external surface and the coated portion of the first minor external surface together forming an electrically conductive pathway, wherein the at least. one electrically conductive material coating the first major external surface and that coating the first minor external surface are the same (preferred) or different. More preferably, at least a portion of at least the first major external surface, at least a portion of at least the second major external surface and at least a portion of the first minor external surface are coated with one or more layers of at least one electrically conductive material, with the coated portion of the first major external surface, the coated portion of the second major external surface and the coated portion of the first minor external surface together forming an electrically conductive pathway, wherein the at least one electrically conductive material coating the first major external surface, that coating the second major external surface and that coating the first minor external surface are the same (preferred) or different. Also more preferably, at least a portion of at least the first major external surface, at least a portion of at least the second major external surface and at least portions of some of the internal surfaces are coated with one or more layers of at least one electrically conductive material, with the coated portion of the first major external surface, the coated portion of the second major external surface and the coated portions of some of the internal surfaces together forming an electrically conductive pathway, wherein the at least one electrically conductive material coating the first major external surface, the at least one electrically conductive material coating the second major external surface and the at least one electrically conductive material coating at least some of the internal surfaces are the same (preferred) or different. In these embodiments of the gas diffusion layer, the first major external surface is in contact with an electrode when the gas diffusion layer is installed in a fuel cell, wherein the second major external surface is optionally in contact with a bipolar plate.

In the gas diffusion layer of the present invention, the external surface or one of the external surfaces of the porous material having at least a portion coated with the at least one electrically conductive material is useful as an external surface in contact with an electrode when the gas diffusion layer is installed in a fuel cell.

In the gas diffusion layer of the present invention, when at least a portion of an external surface of the porous material is coated with the at least one electrically conductive material, preferably that external surface is substantially entirely coated with the at least one electrically conductive material. The external surface being substantially entirely coated with the at least one electrically conductive material is especially suitable to be the external surface in contact with an electrode when the gas diffusion layer is installed in a fuel cell.

For instance, if the porous material is a flexible reticulated polymer foam, the porous material comprises a network of strands forming interstices therebetween, wherein at least a portion of the network of such strands at the external surface of the porous material is coated with one or more layers of the at least one electrically conductive material. Preferably, at least a portion of the network of such strands at the external surface of the porous material and at least a portion of the network of the strands inside the porous material are coated with one or more layers of the at least one electrically conductive material. Preferably, at least some of the strands on a surface of the gas diffusion layer that will come in contact with an electrode when installed in a fuel cell are coated with one or more layers of the at least one electrically conductive material. More preferably, in addition to at least some of the strands on the surface of the gas diffusion layer that will come in contact with the electrode being coated with the at least one electrically conductive material, at least some of the strands inside the gas diffusion layer are coated with one or more layers of the at least one electrically conductive material. Even more preferably, (i) at least some of the strands of the porous material at the external surface of the gas diffusion layer that will come in contact with the electrode, (ii) at least some of the strands of the porous material inside the gas diffusion layer, and (iii) at least some of the strands of the porous material at an external surface of the gas diffusion layer that will come in contact with a bipolar plate when the gas diffusion layer is installed in the fuel cell are coated with one or more layers of the at least one electrically conductive material to create an electrically conductive path from the electrode to the bipolar plate.

The porous material for the gas diffusion layer of the invention can comprise a porous polymeric material or porous inorganic material with the porous polymeric material preferred over the porous inorganic material. The porous polymeric material can be selected from foams, bundled fibers, matted fibers, needled fibers, woven or nonwoven fibers, porous polymers made by pressing polymer beads, Porex and Porex like polymers, i.e. porous polyolefins such as porous polyethylene or porous polypropylene which can be prepared by blending two polymers and removing one of the polymers by dissolving it. The porous polymeric material preferably is selected from foams, bundled fibers, matted fibers, needled fibers, and woven or nonwoven fibers. More preferably, the porous polymeric material is selected from polyurethane foams (preferably felted polyurethane foams, reticulated polyurethane foams, or felted reticulated polyurethane foams), melamine foams, polyvinyl alcohol foams, or nonwoven felts, woven fibers or bundles of fibers made of polyamide such as nylon, polyethylene, polypropylene, polyester such as polyethylene terephthalate, cellulose, modified cellulose such as Rayon, polyacrylonitrile, and mixtures thereof. The porous polymeric material is, further more preferably, a foam such as a polyurethane foam, e.g. felted polyurethane foam, reticulated polyurethane foam, or felted reticulated polyurethane foam. Even more preferably, the porous polymeric material is a reticulated polymer foam such as a reticulated polyurethane foam. Most preferably, the porous polymeric material is a flexible reticulated polyurethane foam. Certain inorganic porous materials, such as sintered inorganic powders of silica or alumina, can also be used as the porous material.

A reticulated foam is produced by removing the cell windows from the cellular polymer structure, leaving a network of strands and thereby increasing the fluid permeability of the resulting reticulated foam. Foams may be reticulated by in situ, chemical or thermal methods known to those of skill in foam production.

If the porous material of a gas diffusion layer of the invention comprises a foam, the foam can be a polyether polyurethane foam having a pore size in the range of about 5 to about 150 pores per linear inch, and a density in the range of about 0.5 to about 8.0 pounds per cubic foot prior to coating.

The porous material can be of any physical shape as long as it has at least one flat surface for making contact with one of the electrodes when the gas diffusion layer is installed in a fuel cell. Thus, when the porous material of a gas diffusion layer of the invention comprises a foam such as a flexible reticulated polyurethane foam, the foam can be of any physical shape when not compressed and not installed in a fuel cell as long as the foam, uncompressed or compressed, has at least one flat surface for making contact with an electrode when installed in a fuel cell.

Exemplary inherently conductive polymers, also known as electrically conductive polymers, include polyacetylene, polyaniline, polypyrrole, polythiophene, polyethylenedioxythiophene, polyfuran, poly(p-phenylene vinylene) (with polyaniline, polypyrrole, polythiophene and polyethylenedioxythiophene being preferred, with polyaniline, polypyrrole and polyethylenedioxythiophene being more preferred), and composites of inherently conductive polymers with amorphous carbon particulates, graphite powder or graphite flakes (e.g. polyaniline-graphite, polypyrrole-graphite or polyethylenedioxythiophen-graphite composites, with polyaniline-graphite composites being preferred). Polyaniline, polyaniline-graphite, polypyrrole and polyethylenedioxythiophene are particularly preferred as the at least one inherently conductive polymer of the at least one electrically conductive material coating the at least a portion of the at least one external surface of the gas diffusion layer of the present invention.

In addition to the at least one inherently conductive polymer, the at least one electrically conductive material that coats the surface(s) of the gas diffusion layer can further contain at least one electrically conductive substance other than the inherently conductive polymer. Examples of the at least one electrically conductive substance other than the inherently conductive polymer include electrically conductive carbon (e.g. amorphous carbon and graphite), metals (e.g. nickel, gold, platinum, cobalt, chromium, copper, indium, aluminum, titanium, zirconium, iron, iridium, osmium, rhenium, ruthenium, rhodium, palladium, manganese, and vanadium), alloys of such metals, salts of such metals, and mixtures thereof, such as a mixture of a metal and amorphous carbon or graphite. The at least one electrically conductive substance, preferably, is selected from graphite, nickel, gold, platinum, cobalt, chromium, copper, indium, aluminum, titanium, zirconium, alloys of such metals, salts of such metals, and mixtures thereof. Preferably, the at least one electrically conductive material has a resistivity less than 20 ohm-cm, most preferably less than 1 ohm-cm.

In this application, the term “coated” means intimately adhered to. When a portion of the at least one surface of the porous material is “coated” with an electrically conductive material, the electrically conductive material is intimately adhered to the portion of the at least one surface leaving substantially no gap between the solid matrix of the “coated” portion and the electrically conductive material. Therefore, when a surface of a porous material is “coated” with an electrically conductive material to make a gas diffusion layer according to the present invention, a porous material having a metal layer crimped onto a surface of the porous material is excluded. When a segment of a strand of the solid matrix of a porous material forming a gas diffusion layer of the present invention is “coated” with an electrically conductive material, substantially the entire external surface of the segment has the electrically conductive material intimately adhered thereto so that a cross-sectional view of the segment shows a core 20 of the solid matrix surrounded by and directly in contact with a layer 22 of the electrically conductive material (e.g. see FIG. 3).

The at least a portion of the surface or portions of the surfaces of the porous material may be coated with the at least one electrically conductive material using one or a combination of various coating methods, such as electroplating, electroless plating, plasma vapor deposition, sputtering, arc forming, a dip and nip coating process or by painting at least a portion of the surface or portions of the surfaces of the porous material with a solution, dispersion, paint or slurry containing the inherently conductive polymer in the form of particulates or a solution dispersed in a liquid medium with or without a binder such as acrylate. If polyurethane foam is used as the porous material, the coated polyurethane foam retains compressibility, recoverability and flexibility. Sheets of such coated polyurethane foam can be looped onto a roll for ease of transport and dispensing. In one preferred embodiment, the solution, dispersion, paint or slurry comprises (a) inherently conductive polymer particulates, (b) inherently conductive polymer particulates and electrically conductive carbon particulates, (c) inherently conductive polymer particulates and metal particulates, (d) inherently conductive polymer particulates, electrically conductive carbon particulates and metal particulates dispersed in a liquid binder.

The porous material may be impregnated or coated using a “dip and nip” coating process or by painting the foam surface with a solution, dispersion, paint or slurry containing at least one inherently conductive polymer, optionally with the addition of electrically conductive carbon particulates and/or metal particulates, dispersed in a liquid medium. The liquid medium can include water, a water-soluble organic solvent, a water-insoluble organic solvent, a mixture of water and a water-soluble organic solvent, a mixture of water and a water-insoluble organic solvent, and a mixture of a water-soluble organic solvent and a water-insoluble organic solvent.

The invention provides a process of preparing a gas diffusion layer, containing the following steps:

(1) dispersing at least one electrically conductive material comprising at least one inherently conductive polymer in a liquid medium to form a mixture, wherein the at least one inherently conductive polymer can be dispersed in a particulate or solution form, or the at least one inherently conductive polymer can be formed in the liquid medium by polymerization and then dispersed, the liquid medium comprising (a) water, (b) at least one water-soluble organic solvent, (c) at least one water-insoluble organic solvent, (d) at least one water-soluble organic solvent and at least one water-insoluble organic solvent, (e) at least one water-soluble organic solvent and water, or (f) at least one water-insoluble organic solvent and water;

(2) providing a porous material comprising a solid matrix, interconnected pores or interstices therethrough, at least one external surface and internal surfaces;

(3) applying the mixture onto at least one portion of the at least one external surface of the porous material; and

(4) drying the porous material resulting from step (3) to obtain the gas diffusion layer, wherein one of the ways of drying is done by placing the porous material resulting from step (3) in a room to be air dried, in an oven, in vacuum or by blowing hot air at the porous material resulting from step (3).

Optionally, if the at least one inherently conductive polymer is formed by polymerization in the liquid medium and then dispersed to obtain the mixture in step (1), step (4) can be performed by drying the porous material resulting from step (3) to obtain a dried porous material, washing the dried porous material to remove any remaining reactant(s), e.g. monomer, of the polymerization reaction, and then drying the porous material again to obtain the gas diffusion layer. Alternatively, if the at least one inherently conductive polymer is formed by polymerization in the liquid medium and then dispersed in step (1), any remaining reactant(s) can be removed from the mixture in step (1) before the mixture is applied in step (3).

When the liquid medium contains a mixture of water and a water-insoluble organic solvent, or a mixture of a water-soluble organic solvent and water-insoluble organic solvent, the ratio by weight of water and the water-insoluble organic solvent or the ratio by weight of the water-soluble organic solvent and the water-insoluble organic solvent, is preferably between about 3:1 and about 99:1, more preferably ranging from about 4:1 to about 20:1, even more preferably ranging from about 5:1 to about 15:1, also more preferably ranging from about 6:1 to about 10:1, and most preferably about 9:1. When the liquid medium contains the mixture of the water-soluble organic solvent and water-insoluble organic solvent, preferably, the water-soluble organic solvent has a lower boiling point than the water-insoluble organic solvent.

Preferred water-soluble organic solvents include N-methyl-2-pyrrolidone, dioxane, tetrahydrofuran, N,N-dimethylformamide, acetone, methanol, ethanol, isopropanol and propanol. Preferred water-insoluble organic solvents include cyclohexane, C₆-C₁₄ alkane, preferably C₇-C₁₃ alkane such as n-heptane, n-octane, n-nonane and n-decane, benzene, toluene, p-xylene, m-xylene, o-xylene, ethylbenzene, diethylbenzene and anisole. For instance, n-hexane can be used as the liquid medium to disperse the at least one electrically conductive material. Alternatively, for example, a liquid comprising 90 weight % water and 10 weight % xylene can be used as the liquid medium to disperse the at least one electrically conductive material. In one preferred embodiment, the mixture of the at least one electrically conductive material and liquid medium has from about 10 to about 15 percent by weight of the at least one inherently conductive polymer dispersed in the liquid medium, and has a viscosity from about 600 to 800 cP.

Preferably, in addition to the at least one inherently conductive polymer and liquid medium, the mixture can also include particulate electrically conductive carbon, e.g. amorphous carbon particulates or graphite particulates, which can be dispersed in the liquid medium before, during or after the dispersing of the at least one inherently conductive polymer. Preferably, the particulate electrically conductive carbon includes graphite powder that constitutes between about 0.5% and about 15% of the wet weight of the mixture. Alternatively or additionally, the particulate electrically conductive carbon includes graphite flakes that constitute between about 1% and about 25% of the mixture by weight. Alternatively or additionally, the particulate electrically conductive carbon includes amorphous carbon particulates that constitute between about 0.5% and about 15% of the wet weight of the mixture.

When the electrically conductive material contains a mixture of an electrically conductive carbon and at least one inherently conductive polymer, the dry weight ratio of the electrically conductive carbon and the at least one inherently conductive polymer can be between about 99:1 and about 1:99, preferably between about 90:10 and about 10:90, more preferably ranging from about 85:15 to about 30:70, even more preferably ranging from about 80:20 to about 40:60, further more preferably ranging from about 75:25 to about 50:50, and much more preferably ranging from about 75:25 to about 60:40, and most preferably about 75:25 or about 60:40. For instance, the electrically conductive material can contain about 75% amorphous carbon particulates, graphite powder or graphite flakes and about 25% polyaniline in terms of dry weight. Alternatively, the electrically conductive material can contain about 60% amorphous carbon particulates, graphite powder or graphite flakes and about 40% polyaniline in terms of dry weight.

The mixture of the at least one electrically conductive material and the liquid medium may be formed by adding at least one inherently conductive polymer in particulate form to a solvent or mixture of solvents. Such particulate form can have a particle size of less than about 0.5 μm. Alternatively, such particulate form can have a particle size in the range of from about 0.2 μm to about 1.0 μm, with a mean particle size of from about 0.3 μm to about 0.5 μm.

Alternatively, if the porous material comprises a porous polymeric material such as a foam, the at least one inherently conductive polymer material may be applied to the porous polymeric material via direct polymerization. The porous polymeric material can be soaked in a solution of a monomer precursor of the at least one inherently conductive polymer. Then the porous polymeric material is transferred to a solution that contains an activating substance, whereby the polymerization reaction ensues and the at least one inherently conductive polymer formed is grafted onto the strands of the porous polymeric material.

Another object of the invention is a process for preparing a gas diffusion layer via direct polymerization, wherein the process contains the following steps:

(1) providing a porous material comprising a solid matrix, interconnected pores or interstices therethrough, at least one external surface and internal surfaces;

(2)(a)(i) applying a mixture comprising a liquid medium and at least one monomer of at least one inherently conductive polymer to at least one portion of the at least one external surface of the porous material; and

(2)(a)(ii) applying an activating substance, preferably in a solution form, to the at least one portion of the at least one external surface of the porous material in a condition that allows the at least one monomer to polymerize in situ in order to form the at least one inherently conductive polymer on the at least one portion of the at least one external surface of the porous material; or

(2)(b)(i) applying an activating substance, preferably in a solution form to at least one portion of the at least one external surface of the porous material; and

(2)(b)(ii) applying a mixture comprising a liquid medium and at least one monomer of at least one inherently conductive polymer to the at least one portion of the at least one external surface of the porous material in a condition that allows the at least one monomer to polymerize in situ in order to form the at least one inherently conductive polymer on the at least one portion of the at least one external surface of the porous material; and

(3) removing any liquid medium, unreacted monomer and activating substance from the porous material to form the gas diffusion layer, wherein the liquid medium comprises (a) water, (b) at least one water-soluble organic solvent, (c) at least one water-insoluble organic solvent, (d) at least one water-soluble organic solvent and at least one water-insoluble organic solvent, (e) at least one water-soluble organic solvent and water, or (f) at least one water-insoluble organic solvent and water, and wherein the mixture can include a dopant, particulate carbon and/or particulate metal.

The liquid medium used in the process via direct polymerization can be the same as the liquid medium used in the previously described process involving dispersing of the at least one inherently conductive polymer with the optional inclusion of particulate carbon and/or particulate metal in the liquid medium. The particulate carbon and/or particulate metal that can optionally be used in the process via direct polymerization can be the same as the particulate carbon and/or particulate metal used in the previously described process involving dispersing the at least one inherently conductive polymer in the liquid medium.

Composites of the at least one inherently conductive polymer coating materials may be applied to the strands of the porous material to form the gas diffusion layer. In addition, two or more layers of the same or different electrically conductive materials may be applied to coat the strands.

Mixtures of inherently conductive coating materials (e.g. mixtures of polyaniline and amorphous carbon or graphite) may be used to coat the at least a portion of the surface or portions of the surfaces of the porous material to form the gas diffusion layer of the present invention. In addition, two or more layers of the same or different electrically conductive materials may be applied to coat the same portion(s) of the surface(s).

In the gas diffusion layer of the present invention, the one or more layers of the at least one electrically conductive material coating the portion(s) of the surface(s) of the porous material can have a total thickness of no more than about 1000, 500, 100, 50, 10, 5, 1 or 0.1 microns, or a total thickness of about 0.1-1000, 1-1000, 1-500, 5-100 or 10-50 microns.

The porous material forming the gas diffusion layer according to the present invention is preferably a foam, more preferably a polyether polyurethane foam, having a pore size in the range of about 5 to about 150 pores per linear inch, and a density in the range of about 0.5 to about 8.0 pounds per cubic foot before being coated with the at least one electrically conductive material.

In some of the embodiments of the gas diffusion layer of the invention, the porous material is a foam. Before being coated with the at least one electrically conductive material, the foam may be felted to increase its surface area by compressing the foam under heat and pressure to a desired thickness and compression ratio, which permanently deforms the foam. Compression ratios of about 1.1 to about 20, preferably about 2 to about 15, more preferably about 3 to about 10, e.g. 3, 4, 5, 6 or 8. For a compression ratio of 10, the foam is compressed to 1/10 of its original thickness.

Felting is carried out under applied heat and pressure to compress a foam structure to an increased firmness and reduced void volume. Once felted, the foam will not recover to its original thickness, but will remain compressed to a reduced thickness. Felted foams generally have a higher surface area per unit volume than unfelted foam, and improved capillarity and water holding than unfelted foams. Yet, felted foams still retain sufficient porosity to transmit gases therethrough. If a felted polyurethane foam (e.g. a felted flexible reticulated polyether polyurethane foam) is selected as the porous material for the gas diffusion layer, such foam should have a density in the range of about 2 to about 40 pounds per cubic foot after felting, and a compression ratio in the range of about 1.1 to about 20, preferably about 2 to about 15, more preferably about 3 to about 10 (e.g. 3, 4, 5, 6 or 8).

The electrically conductive material used to coat the porous material in the present invention can have transition metal particles dispersed in the at least one inherently conductive polymer. The transition metal is selected from the group consisting of: platinum, iridium, osmium, rhenium, ruthenium, rhodium, palladium, iron, cobalt, nickel, chromium, manganese, copper and vanadium. In this embodiment of the gas diffusion layer which can also function as an electrode for a fuel cell, the coating of the at least one electrically conductive material can further contain a polytetrafluoroethylene-based ionomer.

A second aspect of the invention is directed to a device comprising a gas diffusion layer of the invention as described above adjacent to (preferably in contact with) an electrode (either a cathode or anode) for a fuel cell, wherein the electrode comprises at least one catalyst and an optional solid backing layer. The catalyst is for the oxidiation/reduction carried out in the fuel cell and can be platinum. In the device, the at least one external surface of the porous material of the gas diffusion layer having at least a portion of the at least one external surface coated with the at least one electrically conductive material is adjacent to (preferably in contact with) the electrode. Within the scope of the second aspect of the invention is a method of making the device, comprising the step of placing a gas diffusion layer of the invention in contact with a catalyst suitable for use in a fuel cell. For use in hydrogen fuel cells, the gas diffusion layer of the invention is preferably subjected to a hydrophobic treatment before being placed adjacent to an electrode of the fuel cells. The hydrophobic treatment is a treatment of the at least one external surface of a porous material previously coated with an at least one electrically conductive material to render the at least one external surface of the gas diffusion layer hydrophobic. The hydrophobic treatment can be performed by applying a coating of a hydrophobic substance such as polytetrafluoroethylene on the at least one external surface of the porous material previously coated with the at least one electrically conductive material or subjecting the porous material previously coated with the at least one electrically conductive material to a plasma treatment with fluorochemistry such as CF₄. When a gas diffusion layer of the invention subjected to hydrophobic treatment is placed adjacent to a cathode of a hydrogen fuel cell, the hydrophobicity of the at least one external surface prevents flooding of the gas diffusion layer. When a gas diffusion layer of the invention subjected to hydrophobic treatment is placed adjacent to an anode of a hydrogen fuel cell, the hydrophobicity of the at least one external surface of the gas diffusion layer helps to remove water that is created at the cathode and reaches the anode by passing through the PEM.

A third aspect of the invention is directed to a device comprising a gas diffusion layer of the invention as described above adjacent to, preferably in contact with, a separator, wherein the external surface of the separator adjacent to or in contact with the gas diffusion layer is substantially flat. The separator comprises a sheet of a substantially nonporous electrically conductive material, such as a metal. The separator may also be a nonporous, i.e. gas-impermeable, bipolar plate comprising a metal, amorphous carbon or graphite, wherein the external surface of the nonporous bipolar plate adjacent to or in contact with the gas diffusion layer can be, but not required to be, substantially devoid of any groove. In the device, at least a portion of a first external surface of the porous material of the gas diffusion layer is coated with one or more layers of at least one electrically conductive material, wherein the portion of the first external surface is adjacent to (preferably in contact with) the separator. The device may further contain an electrode (either cathode or anode) of a fuel cell, with the electrode disposed adjacent to (preferably in contact with) a second external surface of the porous material of the gas diffusion layer opposite to the first external surface adjacent to the separator, so the device comprises three adjacent layers arranged in the order of: separator, gas diffusion layer and the electrode, wherein at least a portion of the second external surface of the porous material of the gas diffusion layer is coated with the at least one electrically conductive material and wherein (1) the separator, (2) the electrically conductive material coating at least a portion of the first external surface of the gas diffusion layer, (3) the electrically conductive material coating at least a portion of the second external surface of the gas diffusion layer, and (4) the electrode form an electrically conductive path. The electrically conductive material coating at least a portion of the first external surface of the gas diffusion layer and the electrically conductive material coating at least a portion of the second external surface of the gas diffusion layer can form an electrically conductive path by being connected via an electrically conductive wire or electrically conductive material coating a least a portion of internal surfaces of the porous material of the gas diffusion layer. The third aspect of the invention also includes a method of making the device comprising the step of putting the first external surface of a gas diffusion layer of the invention adjacent to a separator, and optionally further placing the second external surface of the gas diffusion layer adjacent to an electrode of a fuel cell, wherein at least portions of the first and second external surfaces are coated with the same or different electrically conductive materials.

A fourth aspect of the invention is directed to a PEM fuel cell having at least one gas diffusion layer of the invention installed. The fuel cell comprises a cathode supplied with a gaseous oxidant stream, an anode supplied with a gaseous stream containing hydrogen, a solid polymer electrolyte or proton exchange membrane (PEM) sandwiched between the cathode and anode, and at least one gas diffusion layer of the invention disposed adjacent to either the cathode or anode on an external surface opposite the PEM.

Preferably, at least two gas diffusion layers of the invention are provided in the fuel cell, with a first gas diffusion layer disposed adjacent to the cathode and a second gas diffusion layer disposed adjacent to the anode, wherein the corresponding gas diffusion layer is disposed on an external surface of the respective electrode opposite the PEM. At least portions of the external surfaces of the first and second gas diffusion layers in contact with the electrodes of the fuel cell are coated with the same or different electrically conductive material. The first and second gas diffusion layers comprise the same or different porous materials, and preferably each comprises a sheet of foam such as polyether polyurethane foam as the porous material. More preferably, each of the porous materials of the first and second gas diffusion layers comprises a sheet of flexible reticulated foam, e.g. flexible reticulated polyurethane foam. The porous materials forming the first and second gas diffusion layers preferably are polyether polyurethane foams that have a pore size in the range of about 5 to about 150 pores per linear inch, and a density in the range of about 0.5 to about 8.0 pounds per cubic foot before being coated with the at least one electrically conductive material. More preferably, a separator is positioned adjacent to (preferably in contact with) an external surface of the first gas diffusion layer opposite the external surface adjacent to the cathode. Even more preferably, another separator is positioned adjacent to (preferably in contact with) an external surface of the second gas diffusion layer opposite the external surface adjacent to the anode. The separators can be thin sheets of a substantially nonporous electrically conductive material, such as a metal. The separators may also be bipolar plates formed from a metal, amorphous carbon or graphite known to persons skilled in the art.

The gas diffusion layer of the invention disposed adjacent to the cathode has a longest dimension. Preferably, the porous material, e.g. foam, in the cathode gas diffusion layer can wick water by capillary action and the water can subsequently be released from the porous material, wherein the porous material has a free rise wick height greater than at least one half of the longest dimension of the cathode gas diffusion layer. The porous material, more preferably, has a free rise wick height greater than at least the longest dimension of the cathode gas diffusion layer. The gas diffusion layer adjacent to the cathode can be in liquid communication with a liquid drawing means for drawing the water previously wicked into the cathode gas diffusion layer out of the fuel cell. The liquid drawing means is preferably a pump. The wicking action of the porous material, e.g. foam, in the gas diffusion layer adjacent to the cathode helps in removing water from the cathode to prevent flooding of the cathode. A gas diffusion layer having a porous material that can wick water is especially preferred in wet fuel cells such as methanol fuel cells.

### BRIEF DESCRIPTION OF THE DRAWINGS

FIG. 1 is a schematic view in side elevation of a fuel cell according to the prior art that has two carbon fabric gas diffusion layers between the MEA and bipolar plates;

FIG. 2 is a schematic view in side elevation of a fuel cell according to the invention that has two compressible coated foam gas diffusion layers between a MEA and two separators in the form of bipolar plates having surface grooves;

FIG. 3 is a schematic view in cross-section of a coated foam strand from one of the gas diffusion layers of FIG. 2 and 4;

FIG. 4 is a schematic view in side elevation of a fuel cell according to the invention that has two compressible coated foam gas diffusion layers between a MEA and two separators, wherein each of the separators has two substantially flat surfaces;

FIGS. 5A and 5B are schematic diagrams of the steps for impregnating a foam sheet with a conductive polymer material using a nip and dip method;

FIG. 6 is a graph of resistivity versus applied pressure, P, for carbon paper (a known gas diffusion layer material) and various samples of conductive polymer coated foams; and

FIG. 7 is a graph of air permeability in L/min versus applied pressure, P, for carbon paper and various samples of conductive polymer coated foams.

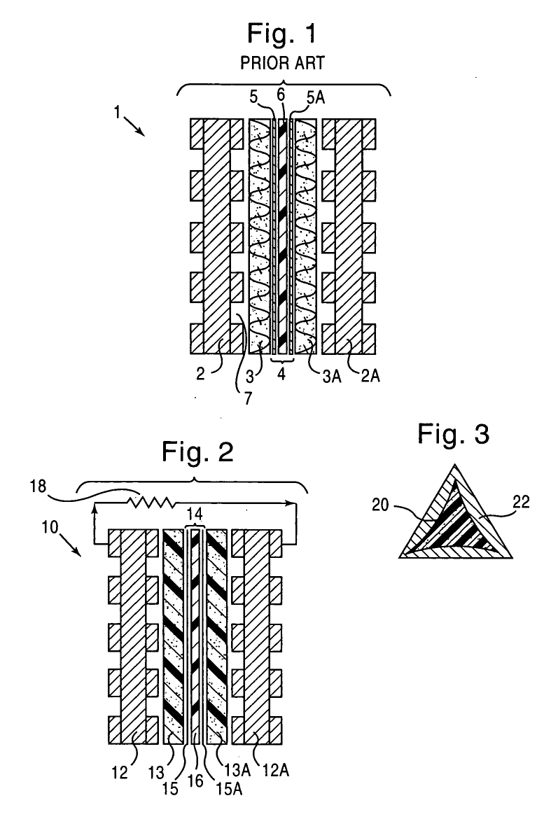

### DESCRIPTION OF THE PREFERRED EMBODIMENTS

Referring first to FIG. 2, a fuel cell 10 includes a membrane electrode assembly (“MEA”) 14 comprising a polymer electrolyte membrane (“PEM”) 16 sandwiched between an associated anode 15 and an associated cathode 15A. Catalyst layers (not shown) are present on each side of the PEM. The PEM must be hydrated to function properly as a proton (hydrogen ion) exchanger and as an electrolyte.

The PEM 16 is a solid, organic polymer, usually polyperfluorosulfonic acid, that comprises the inner core of the membrane electrode assembly (MEA). Commercially available polyperfluorosulfonic acids for use as a PEM are sold by E.I. DuPont de Nemours & Company under the trademark NAFION®). While an MEA with a separate anode and cathode has been illustrated, the gas diffusion layers that are the subject of the present application may be used also with alternate PEMs that have an integral anode and/or cathode.

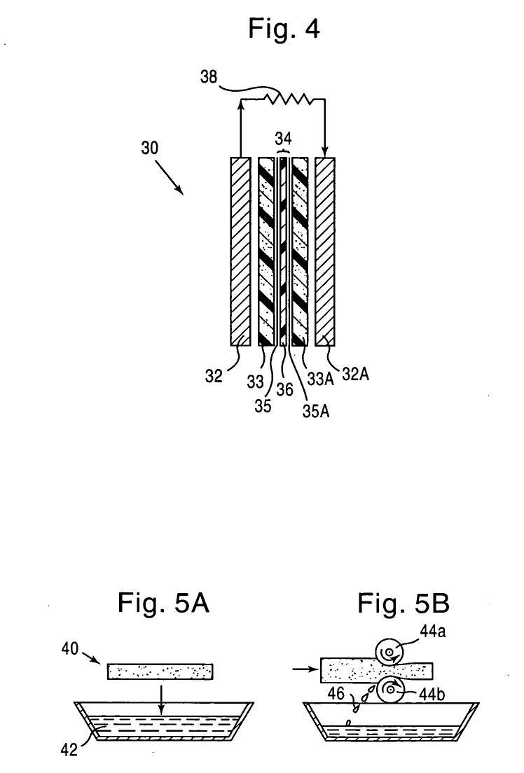

In the fuel cell devices 10, 30 shown in FIGS. 2 and 4, the anode 15, 35 and cathode 15A, 35A are electrodes separated from one another by the PEM 16, 36. The anode carries a negative charge, and the cathode carries a positive charge.

Adjacent to the anode 15, 35 is provided a gas diffusion layer 13, 33 formed from a 7 mm or less, preferably 2 mm or less, thick sheet of 5 to 150, preferably 30 to 100, more preferably 35-90 such as 85, pores per linear inch reticulated polyether polyurethane foam that has been coated with an inherently conductive polymer material 22. See also FIG. 3. Gas diffusion layer 13, 33 helps to distribute hydrogen gas or other source of hydrogen ions uniformly to the anode 15, 35. It also collects the current and provides a path for flow of current (electrons) from the anode through a load 18, 38 to the cathode 15A, 35A via a second gas diffusion layer 13A, 33A. Adjacent to each gas diffusion layer 13, 13A are bipolar plates 12, 12A in the fuel cell device 10 of FIG. 2.

Optionally, in the fuel cell device 30 of FIG. 4, separators 32, 32A formed from an electrically conductive material compatible with the conductive polymer material coating the gas diffusion layer may be provided adjacent to the gas diffusion layers 33, 33A along with or in place of bipolar plates 12, 12A. Adjacent to the cathode 15A, 35A is provided a second gas diffusion layer 13A, 33A formed from a 7 mm or less thick sheet of 35-85, preferably 45-65, pore reticulated polyether polyurethane foam that has been coated with a conductive polymer material 22. The second gas diffusion layer 13A, 33A helps to remove water from the cathode side of the fuel cell to prevent flooding, and allows air or other desired gaseous oxygen source to contact the cathode side to ensure oxygen continues to reach the active sites. The second gas diffusion layer 13A, 33A will transmit current completing the circuit between the anode and cathode.

In practice, each fuel cell component is positioned in contact with the adjacent components. FIG. 2 is presented in an exploded view and shows the components in spaced relation for ease of discussion and understanding.

In operation, a hydrogen source such as hydrogen gas, reformer product or methanol reacts at the surface of the anode 15, 35 to liberate hydrogen ions (H⁺) and electrons (e⁻). The hydrogen ions (H⁺) pass through the PEM 16, 36 and combine with oxygen and electrons on the cathode 15A, 35A side producing water. Electrons (e⁻) cannot pass through the membrane 16, 36 and flow from the anode 15, 35 to the cathode 15A, 35A through an external circuit containing an electric load 18, 38 that consumes the power generated by the cell. The reaction product at the cathode is water. The PEM fuel cell operates at temperatures generally from −20° C. to 95° C., preferably 0° C. to 80° C., and the liberated water most often is in vapor form.

The fuel cell electrochemical reactions are:

For hydrogen fuel:

H₂→2H⁺+2e⁻

O₂+2H⁺+2e⁻→H₂O

H₂+½O₂→H₂O(E=1.23 v)

For methanol fuel:

CH₃OH+H₂O→CO₂+6H⁺+6e⁻

3/2O₂+6H⁺+6e⁻→3H₂O

CH₃OH+3/2O₂→2H₂O+CO₂ (E=1.21 v)

The second gas diffusion layer 13A, 33A allows the water molecules or vapor produced at the cathode 15A, 35A to escape away from the reactive sites on the cathode 15A, 35A. The gas diffusion layers 13, 13A, 33, 33A according to the invention have a thickness in the range of 0.1 to 10 mm, preferably from 0.2 to 4.0 mm, and most preferably less than about 2.0 mm.

The gas diffusion layers 13, 13A, 33, 33A can be formed from polyurethane foam, felted polyurethane foam, reticulated polyurethane foam, and felted reticulated polyurethane foam. A particularly preferred gas diffusion layer is formed from a flexible reticulated polyether polyurethane foam having a density in the range of 0.5 to 8.0 pounds per cubic foot and a pore size in the range of 5 to 150, preferably 30 to 100, more preferably 35 to 90, even more preferably 40 to 75 or 45 to 65, pores per linear inch (alternatively greater than 70 pores per linear inch) before coating. Flexible polyurethane foams well suited for use as gas diffusion layers should rebound following compression and bend in a 3-inch loop without failing catastrophically (e.g. cracking, tearing, deforming, taking a permanent set). ASTM D3574.

Referring to FIG. 3, the highly inherently conductive polymer material 22 is coated onto the strands 20 of polyurethane foam to form a gas diffusion layer. The coating intimately surrounds each strut or strand in the cellular polyurethane network. The foam struts remain a component in the final gas diffusion layer, and are not burned or sintered away.

Inherently conductive polymers are a class of polymers with electrical resistivities in the range of 0.1 to 300 S/cm. Preferably, the inherently conductive polymer in the electronically conductive material used to coat a porous material to form a gas diffusion layer of the invention is polyaniline, polyactylene, polypyrrole, polythiophene, polyfuran, polyethylenedioxythiophene, poly(p-pheylene vinylene), and mixtures thereof, and composites thereof with particulate graphite or carbon. The inherently conductive polymers contain heteroatoms (N, S and/or 0) in their backbone monomers. Polyaniline, polypyrrole, polythiophene and polyethylenedioxythiophene are more preferred as the inherently conductive polymer. Even more preferably, the inherently conductive polymer is polyaniline. A particularly preferred electrically conductive material comprising an inherently conductive polymer is a polyaniline-graphite composite.

Preferably, the inherently conductive polymer is treated with at least one dopant or is synthesized with at least one dopant before being used in the electrically conductive material for coating the porous material in the invention because the at least one dopant can result in an inherently conductive polymer having higher electrical conductivity. The at least one dopant can be an acid, such as a Bronsted acid or Lewis acid. Thus, to be used as the inherently conductive polymers, polyaniline, polyactylene, polypyrrole, polythiophene, polyfuran, polyethylenedioxythiophene, poly(p-pheylene vinylene), and mixtures thereof, and composites thereof with particulate graphite or carbon are preferably treated with the at least one dopant. Acids that can be used as the at least one dopant include, but are not limited to, HCI, nitric acid, phosphoric acid, phosphorous acid, phosphonous acids, phosphonic acids, phosphinous acids, phosphinic acids, sulfonic acids, carboxylic acids, ferric chloride and aluminum chloride. Examples of sulfonic acids are aromatic sulfonic acids such as benzenesulfonic acid, toluenesulfonic acid, dodecylbenzenesulfonic acid, butylbenzenesulfonic acid, and naphthalenesulfonic acid. Examples of phosphonic acids that can be used as the at least one dopant are benzenephosphonic acid (i.e. RP(O)(OH)₂, wherein R is phenyl), toluenephosphonic acid (i.e. RP(O)(OH)₂, wherein R is tolyl), dodecylbenzenephosphonic acid (i.e. RP(O)(OH)₂, wherein R is dodecylphenyl) such as p-dodecylbenzenephosphonic acid, butylbenzenephosphonic acid (i.e. RP(O)(OH)₂, wherein R is butylphenyl), and naphthalenephosphonic acid (i.e. RP(O)(OH)₂, wherein R is naphthyl). More preferably, the at least one dopant is HCI, phosphoric acid or dodecylbenzenephosphonic, with dodecylbenzenephosphonic acid such as p-dodecylbenzenephosphonic acid being most preferred, in particular when the inherently conductive polymer is polyaniline. The dopant can be ferric chloride, particularly when the inherently conductive polymer is polythiophene.

Preferred water-soluble organic solvents include N-methyl-2-pyrrolidone, dioxane (boiling point 105° C.), tetrahydrofuran (boiling point 67° C.), N,N-dimethylformamide (boiling point 149° C.), acetone (boiling point 56.2° C.), methanol (boiling point 65° C.), ethanol (boiling point 78.5° C.), isopropanol (boiling point 82.4° C.) and propanol (boiling point 97.4° C.). Preferred water-insoluble organic solvents include n-heptane (boiling point 98.4° C.), benzene (boiling point 80.1° C.), toluene (boiling point 110.6° C.), p-xylene (boiling point 138.3° C.), m-xylene (boiling point 139.1° C.), o-xylene (boiling point 144.4° C.), ethylbenzene (boiling point 136.2° C.), o-diethylbenzene (boiling point 183.4° C.), m-diethylbenzene (boiling point 181° C.), p-diethylbenzene (boiling point 183.8° C.) and anisole (boiling point 155° C.).

Preferably, the liquid medium also includes an organic compound, for example an aromatic sulfonic acid, that acts as a dopant of the inherently conductive polymer and, optionally, also as a dispersant of the inherently conductive polymer. Depending on the nature of the base polymer and the inherently conductive polymer, this organic compound may also increase the compatibility of the inherently conductive polymer with the pore surfaces of the base foam. For example, aromatic sulfonic acids generally enhance the compatibility of polyaniline with polyurethane base foam. Examples of dopants include phosphonic acids and aromatic sulfonic acids such as benzenephosphonic acid, toluenephosphonic acid, dodecylbenzenephosphonic acid, butylbenzenephosphonic acid, naphthalenephosphonic acid, benzenesulfonic acid, toluenesulfonic acid, dodecylbenzenesulfonic acid (DBSA), butylbenzenesulfonic acid, naphthalenesulfonic acid and camphor sulfonic acid.

The liquid medium can also include a binder. Preferably, the binder constitutes between about 0.03 weight % and about 2.5 weight % of the mixture containing the at least one electrically conductive material, binder and liquid medium with the optional inclusion of the dopant. If the liquid medium does not include any binder, a porous polymeric material coated with the at least one electrically conductive material can be pressed at a temperature ranging from 70° C. to 200° C., preferably from 100° C. to 150° C., more preferably at about 130° C., for about 1 minute to about 10 minutes, preferably about 2 minutes to about 5 minutes, more preferably about 2 minutes, in order to prevent the shedding of the electrically conductive material from the coated porous polymeric material.

The conductive coating may be applied using various methods known to those of skill in the art, including dipping and nipping or painting. In a dipping and nipping coating process illustrated schematically in FIG. 5, the foam 40 is first dipped in a coating liquid or liquid mixture 42 and then compressed in the nip formed between two compression platens or rollers 44a, 44b. The “nipping” step squeezes the coating liquid through the foam to force intimate contact with the foam strands, and also causes excess coating liquid 46 to be expelled from the foam. If more than one cycle is desired, the dipping and nipping is generally repeated for up to about 7 cycles, e.g. 3 cycles.

Alternatively, the conductive polymer coating may be applied to the foam via direct polymerization. In such process, a liquid medium containing a monomer, e.g. aniline, of an inherently conductive polymer, e.g. polyaniline, and a solution of an oxidizer, e.g. persulfate ammonium, are applied onto at least a portion of at least an external surface of the form. The inherently conductive polymer is formed in situ while the foam is held within the mixture of the monomer liquid and oxidizer solution. The direct polymerization process can be performed by sequential dipping of the foam in the monomer liquid and then oxidizer solution, or in the oxidizer solution and then the monomer liquid, followed by washing to remove any unreacted monomer liquid and oxidizer solution. Such procedure may be repeated 3-7 times. An embodiment of the direct polymerization process is illustrated in Example 3 below.

A protective pre-coating of a non-conductive polymer may also be applied to the foam strands before the conductive coating is applied. Such pre-coatings may include acrylics, vinyls, natural or synthetic rubbers, or similar materials, and may be applied using a water borne or solvent borne coating process, such as dipping, or painting, optionally followed by nipping.

Following coating with the inherently conductive polymer material, the gas diffusion layer should have a surface resistivity less than 20 ohm-cm, preferably less than 1 ohm-cm. The gas diffusion layer must be capable of collecting and conducting the current from the anode of one cell for use in a load and return, via conduction in another gas diffusion layer, to the cathode of an adjacent cell.

Preferred embodiments of the gas diffusion layer of the invention include a gas diffusion layer having a polyether polyurethane foam with about 35 to about 90, preferably about 40 to about 75, even more preferably about 45 to about 65, pores per linear inch (e.g. 45, 60 or 88 ppi) felted with a compression ratio of about 4 to about 8 as the porous material, wherein the porous material is coated with an electrically conductive material containing electrically conductive carbon such as particulate graphite (e.g. graphite flakes) and polyaniline in a dry weight ratio ranging from about 60:40 to about 75:25 (e.g. 60:40 or 75:25), with the polyaniline doped with HCI, phosphoric acid, or preferably dodecylbenzenephosphonic acid. The gas diffusion layer preferably is about 0.5 mm to about 2 mm thick before being assembled in a fuel cell.

Significant advantages of the gas diffusion layers according to the invention include compressibility, ease of handling and flexibility. The gas diffusion layers can readily conform to the space into which they are installed. The foams can rebound after compression, such that good contact may be maintained between (a) the gas diffusion layer and one of the external surfaces of the respective anode or cathode that is adjacent to an external surface of the gas diffusion layer, and (b) the gas diffusion layer and one of the external surfaces of an optional separator, which can be in the form of a bipolar plate with or without surface grooves, adjacent to another external surface of the gas diffusion layer. Improved contact means greater efficiency in current transfer. Moreover, because the gas diffusion layers according to the invention are made with flexible and compressible foams, they do not have the drawbacks associated with perforated or foamed metals, which can puncture the MEA and deform when handled during fuel cell assembly. The flexible and compressible gas diffusion layers of the present invention also have advantages over traditional carbon papers, which papers are fragile and only available in flat sheet form, making them less amenable to automated assembly.

### EXAMPLES

Foam Preparation

A 70 pore per linear inch reticulated polyether polyurethane foam was prepared from the following ingredients:

| Arcol 3020 polyol (from Bayer Corp.) | 100 parts |
|---|---|
| Water | 4.7 |
| Dabco NEM (from Air Products) | 1.0 |
| A-1 (from OSi Specialties/Crompton) | 0.1 |
| Dabco T-9 (from Air Products) | 0.17 |
| L-620 (from OSi Specialties/Crompton) | 1.3 |

Arcol 3020 polyol is a polyether polyol triol with a hydroxyl number of 56 having a nominal content of 92% polypropylene oxide and 8% polyethylene oxide. Dabco NEM is N-ethyl morpholine. A-1 represents NIAX A-1, which is a blowing catalyst containing 70% bis (dimethylaminoethyl)ether and 30% dipropylene glycol. Dabco T-9 is stabilized stannous octoate. L-620 represents NIAX L-620 which is a high efficiency non-hydrolyzable surfactant for conventional slabstock foam.

After mixing for 60 seconds and allowed to degas for 30 seconds, 60 parts of toluene diisocyanate were added. This mixture was mixed for 10 seconds and then placed in a 15″ by 15″ by 5″ box to rise and cure for 24 hours. The resulting foam had a density of 1.4 pounds per cubic foot.

The foam was removed from the box and thermally reticulated. The foam was then felted by compressing the foam to one-third of its original thickness.

Foam samples were cut to a desired size for use in coating and testing. Each sample was weighed and its pre-coating weight recorded.

Highly Inherently Conductive Polymer Preparation

In the examples presented below, the conductive polymer (polyaniline) was prepared as described by X. Wei and A. Epstein, “Synthesis of highly sulfonated polyaniline,” Synthetic Metals, vol. 74, pp. 123-125 (1995). (NH₄)₂S₂O₈ was used as an oxidizer. Preparation of polypyrrole is described in T. H. Chao and J. March, “A study of polypyrrole synthesized with oxidative transition metal ions”, Journal of Polymer Science, Part A: Polymer Chemistry, vol. 26, pp. 743-753 (1988).

### Example 1

An inherently conductive polymer/liquid medium mixture was prepared with polyaniline-graphite flakes dispersed in a xylene-ethanol solvent mixture. The flake particles had a mean particle size of 0.7 μm. The mixture had from 12 to 12.5% by weight of the particles, an aromaticity of from 10 to 20%, a viscosity from 200 to 250cP, and a volume conductivity of 240 siemens/cm (S/cm).

A sample of the foam was coated with the inherently conductive polymer with a dipping and nipping process. The foam sample was dipped into the inherently conductive polymer/liquid medium mixture and then nipped between compression rollers. This dipping and nipping was repeated several times. Thereafter, the impregnated foam sample was dried at 100° C. for 20 minutes. The coated foam was weighed and its post-coating weight was recorded. The percentage of increase in weight was then calculated and recorded as a percentage (% M).

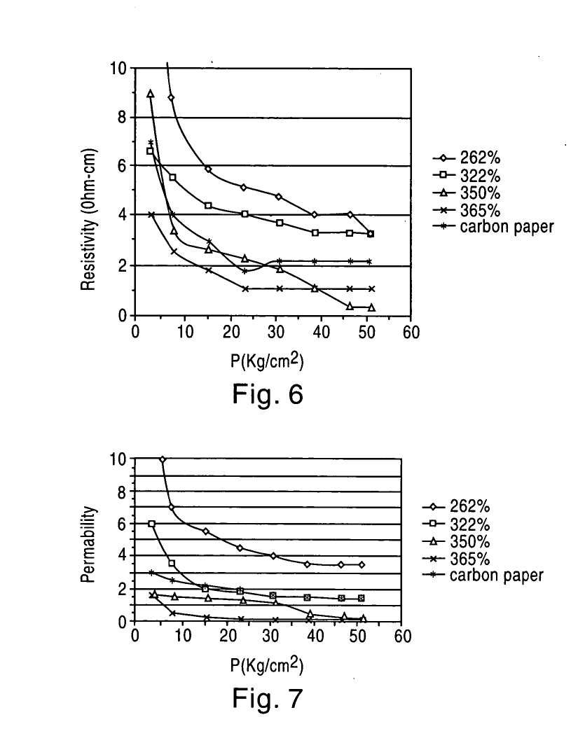

Resistivity, applied pressure and air permeability were measured for the samples at different coating weights, which samples were held under compression to simulate the environment within a PEM fuel cell. The measured parameters were compared with the same parameters measured for carbon paper. The results of the comparison tests are shown in the graphs in FIGS. 6 and 7.

To interpret the results shown graphically in FIGS. 6 and 7, the lower the resistivity the better the expected performance of the material when installed as a gas diffusion layer in PEM fuel cells. Higher resistivity leads to greater parasitic power losses and heat generation. For coating weights of 250% and above, the resistivity of the coated foams was less than 5 ohm-cm. At coating weights of 400% and above, the resistivity of the coated foams was less than 1 ohm-cm.

In contrast, the higher the gas permeability, the better the expected performance of the material when used as a gas diffusion layer in PEM fuel cells. Higher gas permeability means better flow of fuel (hydrogen gas) to the anode and better flow of oxygen to, and water vapor and carbon dioxide away from the cathode in the fuel cell.

In addition, the flexible conductive polymer coated foam of the invention rebounds after bending. This characteristic makes the coated foam easier to handle and install in fuel cell applications. Such coated foam may be formed in a sheet and rolled over a roller. The foam according to the invention maintains better contact with a bipolar plate, separator or PEM at a lower force, which leads to greater fuel cell efficiency, easier assembly and possibly a lighter weight design.

### Example 2

A polyurethane foam sample was impregnated with a mixture of a polyaniline-graphite composite dispersed in water as the liquid medium. The polyaniline-graphite flakes had a mean particle size of 0.7 μm (particle size range from 0.1 to 0.9 μm) and were added to a de-ionized water bath and mixed well. The mixture contained approximately 11% by weight solids and had a viscosity of 10 cP. The volume conductivity was from 30 to 35 S/cm. The foam sample was impregnated with the inherently conductive polymer material by a nip and dip process. The coated sample was then dried for 20 minutes at 100°0 C. The coating weights were measured. At coating weights of 180% M and above, the coated foam had a resistivity of less than 20 Ohm-cm.

While coating without organic solvents in the liquid medium was somewhat more difficult and somewhat less effective for increasing the measured conductivity as compared to the coated foam in Example 1, the mixture formed with water as the liquid medium did have other advantages. It had a lower cost, caused less foam swelling, and the lack of organic solvents made it safer for the environment (fewer disposal problems).

### Example 3

A polyurethane foam sample was immersed in a solution of an aniline salt in water. The sample was then transferred to an aqueous solution of an oxidant (persulfate ammonium). While the sample was held in the solution for 12 to 15 hours at about 0 to 2° C., a polymerization reaction proceeded to form polyaniline in situ grafted over the polyurethane foam sample. The foam grafted with polyaniline was removed and washed with water.

The detailed description and the above examples are for illustration purposes only for some of the preferred embodiments of the invention. Various changes of the detail and form are within the ordinary skill in the art. The scope of the claimed invention must be measured by the claims below, and not by the above examples or the detailed description of the preferred embodiments.

1. A gas diffusion layer for a polymer electrolyte or proton exchange membrane (PEM) fuel cell, comprising a porous material and at least one electrically conductive material, wherein
the porous material comprises a solid matrix, interconnected pores or interstices therethrough, at least one external surface, and internal surfaces;
at least a portion of the at least one external surface of the porous material is coated with the at least one electrically conductive material; and
the at least one electrically conductive material comprises at least one inherently conductive polymer.

2. The gas diffusion layer of claim 1, wherein at least portions of the internal surfaces are coated with at least one electrically conductive material comprising at least one inherently conductive polymer, the at least one electrically conductive material coating the internal surfaces being the same as or different from the at least one electrically conductive material coating the at least one external surface; and wherein the at least one electrically conductive material coating the at least portions of the internal surfaces and the at least one electrically conductive material coating the at least a portion of the at least one external surface together form an electrically conductive path.

3. The gas diffusion layer of claim 2, wherein
the at least one external surface of the porous material comprises at least first and second external surfaces;
at least a portion of the first external surface of the porous material is coated with the at least one electrically conductive material;
at least a portion of the second external surface of the porous material is coated with at least one electrically conductive material comprising at least one inherently conductive polymer; and
the at least one electrically conductive material coating the at least a portion of the first external surface of the porous material, the at least one electrically conductive material coating the at least a portion of the second external surface, and the at least one electrically conductive material coating the at least portions of the internal surfaces together form an electrically conductive path.

4. The gas diffusion layer of claim 3, wherein the at least one electrically conductive material coating the at least portions of the internal surfaces, the at least one electrically conductive material coating the at least a portion of the first external surface of the porous material and the at least one electrically conductive material coating the at least a portion of the second external surface of the porous material are the same.

5. The gas diffusion layer of claim 1, wherein the at least one external surface of the porous material comprises at least first and second external surfaces;
at least a portion of the first external surface of the porous material is coated with the at least one electrically conductive material;
at least a portion of the second external surface of the porous material is coated with at least one electrically conductive material comprising at least one inherently conductive polymer; and
the at least one electrically conductive material coating the at least a portion of the first external surface of the porous material and the at least one electrically conductive material coating the at least a portion of the second external surface together form an electrically conductive path.

6. The gas diffusion layer of claim 3, wherein the at least one electrically conductive material coating at least a portion of the first external surface, the at least one electrically conductive material coating at least a portion of the second external surface and the at least one electrically conductive material coating at least portions of the internal surfaces further comprise at least one electrically conductive substance other than an inherently conductive polymer.

7. The gas diffusion layer of claim 1, wherein the at least one inherently conductive polymer is selected from the group consisting of polyacetylene, polyaniline, polypyrrole, polythiophene, polyethylenedioxythiophene, polyfuran, and poly(p-phenylene vinylene).

8. The gas diffusion layer of claim 7, wherein the at least one inherently conductive polymer is selected from the group consisting of polyaniline, polypyrrole, polythiophene and polyethylenedioxythiophene.

9. The gas diffusion layer of claim 1, wherein the at least one electrically conductive material further comprises at least one electrically conductive substance other than an inherently conductive polymer.

10. The gas diffusion layer of claim 1, wherein the at least one electrically conductive material further comprises electrically conductive carbon.

11. The gas diffusion layer of claim 10, wherein the electrically conductive carbon comprises a substance selected from amorphous carbon particulates, graphite powder and graphite flakes.

12. The gas diffusion layer of claim 11, wherein the electrically conductive carbon comprises graphite powder and/or graphite flakes.

13. The gas diffusion layer of claim 1, wherein the at least one electrically conductive material comprises a polyaniline-graphite composite, polypyrrole-graphite composite and/or polyethylenedioxythiophen-graphite composite.

14. The gas diffusion layer of claim 13, wherein the at least one electrically conductive material comprises a polyaniline-graphite composite.

15. The gas diffusion layer of claim 10, wherein a dry weight ratio of the electrically conductive carbon and the at least one inherently conductive polymer is between about 99:1 and about 1:99.

16. The gas diffusion layer of claim 15, wherein the dry weight ratio ranges from about 80:20 to about 40:60.

17. The gas diffusion layer of claim 16, wherein the dry weight ratio ranges from about 75:25 to about 60:40.

18. The gas diffusion layer of claim 1, wherein the at least one electrically conductive material further comprises a metal.

19. The gas diffusion layer of claim 18, wherein the metal is selected from the group consisting of nickel, gold, platinum, cobalt, chromium, copper, indium, aluminum, titanium, zirconium, iron, iridium, osmium, rhenium, ruthenium, rhodium, palladium, manganese, vanadium, alloys of such metals, salts of such metals, and mixtures thereof.

20. The gas diffusion layer of claim 3, wherein the at least one inherently conductive polymer is selected from the group consisting of polyacetylene, polyaniline, polypyrrole, polythiophene, polyethylenedioxythiophene, polyfuran, and poly(p-phenylene vinylene).

21. The gas diffusion layer of claim 20, wherein the at least one inherently conductive polymer is selected from the group consisting of polyaniline, polypyrrole, polythiophene and polyethylenedioxythiophene.

22. The gas diffusion layer of claim 3, wherein the at least one electrically conductive material coating the at least a portion of the first external surface and the at least one electrically conductive material coating the at least a portion of the second external surface are the same and further comprise at least one electrically conductive substance other than an inherently conductive polymer.

23. The gas diffusion layer of claim 22, wherein the at least one electrically conductive substance comprises electrically conductive carbon.

24. The gas diffusion layer of claim 23, wherein the electrically conductive carbon comprises amorphous carbon particulates, graphite powder and/or graphite flakes.

25. The gas diffusion layer of claim 3, wherein the at least one electrically conductive material coating the at least a portion of the first external surface and the at least one electrically conductive material coating the at least a portion of the second external surface are the same and comprise a polyaniline-graphite composite, polypyrrole-graphite composite and/or polyethylenedioxythiophen-graphite composite

26. The gas diffusion layer of claim 25, wherein the at least one electrically conductive material coating the at least a portion of the first external surface and the at least one electrically conductive material coating the at least a portion of the second external surface comprise a polyaniline-graphite composite.

27. The gas diffusion layer of claim 26, wherein a weight ratio of graphite and polyaniline in the polyaniline-graphite composite is about 60:40.

28. The gas diffusion layer of claim 26, wherein a weight ratio of graphite and polyaniline in the polyaniline-graphite composite is about 75:25.

29. The gas diffusion layer of claim 3, wherein the at least one electrically conductive material coating the at least a portion of the first external surface further comprises a metal.

30. The gas diffusion layer of claim 29, wherein the metal is selected from the group consisting of nickel, gold, platinum, cobalt, chromium, copper, indium, aluminum, titanium, zirconium, iron, iridium, osmium, rhenium, ruthenium, rhodium, palladium, manganese, vanadium, alloys of such metals, salts of such metals, and mixtures thereof.

31. The gas diffusion layer of claim 30, wherein the metal is nickel or copper.

32. The gas diffusion layer of claim 1, wherein the at least one electrically conductive material further comprises electrically conductive carbon and a metal.

33. The gas diffusion layer of claim 3, wherein the at least one electrically conductive material coating the at least a portion of the first external surface, the at least one electrically conductive material coating the at least a portion of the second external surface and the at least one electrically conductive material coating the at least portions of the internal surfaces are the same and further comprise electrically conductive carbon and a metal.

34. The gas diffusion layer of claim 1, wherein the at least one surface of the external surface coated with the at least one electrically conductive material is hydrophobic.

35. The gas diffusion layer of claim 1, wherein the porous material comprises a porous polymeric material.

36. The gas diffusion layer of claim 34, wherein the porous polymeric material is selected from the group consisting of foams, bundled fibers, matted fibers, needled fibers, woven or nonwoven fibers, porous polymers made by pressing polymer beads, and porous polyolefins.

37. The gas diffusion layer of claim 36, wherein the porous polymeric material is selected from polyurethane foams, melamine foams, polyvinyl alcohol foams, nonwoven felts, woven fibers or bundles of fibers made of polyamide, polyethylene, polypropylene, polyester, cellulose, modified cellulose, polyacrylonitrile, and mixtures thereof.

38. The gas diffusion layer of claim 36, wherein the porous polymeric material is selected from felted polyurethane foams, reticulated polyurethane foams and felted reticulated polyurethane foams.

39. The gas diffusion layer of claim 38, wherein the porous polymeric material is a foam.

40. The gas diffusion layer of claim 39, wherein the porous polymeric material is a polyurethane foam.

41. The gas diffusion layer of claim 40, wherein the porous polymeric material is selected from a felted polyurethane foam, reticulated polyurethane foam and felted reticulated polyurethane foam.

42. The gas diffusion layer of claim 39, wherein the porous polymeric material is a reticulated polymer foam.

43. The gas diffusion layer of claim 42, wherein the porous polymeric material is a reticulated polyurethane foam.

44. The gas diffusion layer of claim 43, wherein the porous polymeric material is a flexible reticulated polyurethane foam.

45. The gas diffusion layer of claim 3, wherein the first external surface coated with the at least one electrically conductive material is hydrophobic.

46. The gas diffusion layer of claim 3, wherein the porous material comprises a porous polymeric material.

47. The gas diffusion layer of claim 45, wherein the porous polymeric material is selected from the group consisting of foams, bundled fibers, matted fibers, needled fibers, woven or nonwoven fibers, porous polymers made by pressing polymer beads and porous polyolefins.

48. The gas diffusion layer of claim 47, wherein the porous polymeric material is selected from polyurethane foams, melamine foams, polyvinyl alcohol foams, nonwoven felts, woven fibers and bundles of fibers made of polyamide, polyethylene, polypropylene, polyester, cellulose, modified cellulose, polyacrylonitrile, and mixtures thereof.

49. The gas diffusion layer of claim 47, wherein the porous polymeric material is selected from felted polyurethane foams, reticulated polyurethane foams and felted reticulated polyurethane foams.

50. The gas diffusion layer of claim 49, wherein the porous polymeric material is a foam.

51. The gas diffusion layer of claim 50, wherein the porous polymeric material is a polyurethane foam.

52. The gas diffusion layer of claim 51, wherein the porous polymeric material is selected from a felted polyurethane foam, reticulated polyurethane foam and felted reticulated polyurethane foam.

53. The gas diffusion layer of claim 50, wherein the porous polymeric material is a reticulated polymer foam.

54. The gas diffusion layer of claim 53, wherein the porous polymeric material is a reticulated polyurethane foam.

55. The gas diffusion layer of claim 54, wherein the porous polymeric material is a flexible reticulated polyurethane foam.

56. A device comprising the gas diffusion layer of claim 1 and an electrode of a PEM fuel cell, wherein the gas diffusion layer is adjacent to the electrode and wherein the at least a portion of the at least one external surface coated with the at least one electrically conductive material is in contact with at least a portion of an external surface of the electrode.

57. The device of claim 56, wherein the electrode is a cathode of the PEM fuel cell.

58. The device of claim 56, wherein the electrode is an anode of the PEM fuel cell.

59. The device of claim 57, further comprising a second gas diffusion layer adjacent to an anode of the PEM fuel cell,
wherein the second gas diffusion layer comprises a porous material and at least one electrically conductive material, the porous material comprising a solid matrix, interconnected pores or interstices therethrough and at least one external surface, at least a portion of the at least one external surface of the porous material being coated with the at least one electrically conductive material comprising at least one inherently conductive polymer; and
wherein the at least a portion of the at least one external surface of the second gas diffusion layer coated with the at least one electrically conductive material is in contact with an external surface of the anode.

60. The device of claim 56, further comprising a separator in contact with an external surface of the porous material of the gas diffusion layer different from the at least one external surface being coated with the at least one electrically conductive material, wherein the separator comprises a substantially gas-impermeable electrically conductive layer.

61. The device of claim 59, further comprising first and second separators, the first separator being adjacent to the gas diffusion layer in contact with the cathode, the first separator in contact with an external surface of the porous material of the gas diffusion layer different from the at least one external surface being coated with the at least one electrically conductive material, the second separator being adjacent to the second gas diffusion layer, the second separator in contact with an external surface of the porous material of the second gas diffusion layer different from the at least one external surface being coated with the at least one electrically conductive material, wherein each of the first and second separators comprising a substantially gas-impermeable electrically conductive layer.

62. The device of claim 60, wherein the separator is a bipolar plate having grooves on at least one external surface.

63. The device of claim 61, wherein the separators are bipolar plates each having grooves on at least one external surface.

64. A device comprising a gas diffusion layer of claim 3 and an electrode of a PEM fuel cell, wherein the gas diffusion layer is adjacent to the electrode and wherein the at least a portion of the first external surface coated with the at least one electrically conductive material is in contact with at least a portion of an external surface of the electrode.

65. The device of claim 64, wherein the electrode is a cathode of the PEM fuel cell.

66. The device of claim 64, wherein the electrode is an anode of the PEM fuel cell.

67. The device of claim 65, further comprising an anode of the PEM fuel cell and a second gas diffusion layer adjacent to the anode,
wherein the second gas diffusion layer comprises a porous material and at least one electrically conductive material, the porous material comprising a solid matrix, interconnected pores or interstices therethrough, at least first and second external surfaces, and internal surfaces, at least portions of the at least first and second external surfaces and internal surfaces of the porous material being coated with at least one electrically conductive material comprising at least one inherently conductive polymer, the at least one electrically conductive material coating the at least portions of the first and second external surfaces and internal surfaces of the porous material forming an electrically conductive path; and
wherein the at least a portion of the first external surface of the porous material of the second gas diffusion layer coated with the at least one electrically conductive material is in contact with at least a portion of an external surface of the anode.

68. The device of claim 64, further comprising a separator, the separator comprising a substantially gas-impermeable electrically conductive layer, the gas diffusion layer being adjacent to the separator, wherein the second external surface of the porous material of the gas diffusion layer is in contact with an external surface of the separator, and wherein the separator and the at least one electrically conductive material coating the at least portions of the at least first and second external surfaces and internal surfaces of the porous material together form an electrically conductive path.

69. The device of claim 67, further comprising at least first and second separators, each of the separators comprising a substantially gas-impermeable electrically conductive layer, the first gas diffusion layer being adjacent the first separator, the second gas diffusion layer being adjacent the second separator, the second external surface of the porous material of the first gas diffusion layer being in contact with an external surface of the first separator, the second external surface of the porous material of the second gas diffusion layer being in contact with an external surface of the second separator; wherein the first separator and the at least one electrically conductive material coating the at least portions of the first and second external surfaces and internal surfaces of the porous material of the first gas diffusion layer and the cathode together form an electrically conductive path; and wherein the second separator and the at least one electrically conductive material coating the at least portions of the first and second external surfaces and internal surfaces of the porous material of the second gas diffusion layer and the anode together form an electrically conductive path.

70. A process of preparing a gas diffusion layer of claim 1, comprising the following steps:
(1) dispersing at least one electrically conductive material comprising at least one inherently conductive polymer in a liquid medium to form a mixture, the liquid medium comprising (a) water, (b) at least one water-soluble organic solvent, (c) at least one water-insoluble organic solvent, (d) at least one water-soluble organic solvent and at least one water-insoluble organic solvent, (e) at least one water-soluble organic solvent and water, or (f) at least one water-insoluble organic solvent and water;
(2) providing a porous material comprising a solid matrix, interconnected pores or interstices therethrough, at least one external surface and internal surfaces;
(3) applying the mixture onto at least a portion of the at least one external surface of the porous material; and
(4) drying the porous material resulting from step (3) to obtain the gas diffusion layer.

71. The process of claim 70, wherein the liquid medium comprises at least one water-soluble organic solvent and at least one water-insoluble organic solvent.

72. The process of claim 71, wherein a ratio by weight of the at least one water-soluble organic solvent and at least one water-insoluble organic solvent in the liquid medium is between about 3:1 and about 99:1.

73. The process of claim 72, wherein the ratio by weight of the at least one water-soluble organic solvent and at least one water-insoluble organic solvent in the liquid medium ranges from about 4:1 to about 20:1.

74. The process of claim 73, wherein the ratio by weight of the at least one water-soluble organic solvent and at least one water-insoluble organic solvent in the liquid medium ranges from about 6:1 to about 10:1.

75. The process of claim 74, wherein the ratio by weight of the at least one water-soluble organic solvent and at least one water-insoluble organic solvent in the liquid medium is about 9:1.

76. The process of claim 71, wherein the at least one water-soluble organic solvent has a lower boiling point than the at least one water-insoluble organic solvent.

77. The process of claim 71, wherein the at least one water-soluble organic solvent is selected from the group consisting of N-methyl-2-pyrrolidone, dioxane, tetrahydrofuran, N,N-dimethylformamide, acetone, methanol, ethanol, isopropanol and propanol; and the at least one water-insoluble organic solvent is selected from the group consisting of cyclohexane, C₆-C₁₄ alkane, benzene, toluene, p-xylene, m-xylene, o-xylene, ethylbenzene, diethylbenzene and anisole.

78. The process of claim 70, wherein the liquid medium comprises water.

79. The process of claim 70, wherein the mixture has from about 10 to about 15 percent by weight of the at least one inherently conductive polymer dispersed in the liquid medium, and has a viscosity from about 600 to 800 cP.

80. The process of claim 70, wherein the at least one inherently conductive polymer is selected from the group consisting of polyacetylene, polyaniline, polypyrrole, polythiophene, polyethylenedioxythiophene, polyfuran, and poly(p-phenylene vinylene).

81. The process of claim 80, wherein the at least one inherently conductive polymer is selected from the group consisting of polyaniline, polypyrrole, polythiophene and polyethylenedioxythiophene.

82. The process of claim 81, wherein the at least one inherently conductive polymer is polyaniline.

83. The process of claim 70, wherein the at least one electrically conductive material in step (1) further comprises electrically conductive carbon.

84. The process of claim 83, wherein the electrically conductive carbon comprises amorphous carbon particulates, graphite powder and/or graphite flakes.

85. The process of claim 70, wherein the at least one electrically conductive material comprises a polyaniline-graphite composite, polypyrrole-graphite composite and/or polyethylenedioxythiophen-graphite composite

86. The process of claim 85, wherein the at least one electrically conductive material comprises a polyaniline-graphite composite.

87. The process of claim 70, wherein the mixture in step (1) further comprises electrically conductive carbon with a weight ratio of the electrically conductive carbon and the at least one inherently conductive polymer being between about 99:1 and about 1:99.

88. The process of claim 70, wherein the mixture in step (1) further comprises electrically conductive carbon with a weight ratio of the electrically conductive carbon and the at least one inherently conductive polymer ranging from about 80:20 to about 40:60.

89. The process of claim 70, wherein the mixture in step (1) further comprises electrically conductive carbon with a weight ratio of the electrically conductive carbon and the at least one inherently conductive polymer ranging from about 75:25 to about 50:50.

90. The process of claim 70, wherein the at least one inherently conductive polymer is in the form of a particulate when dispersed in the liquid medium in step (1).

91. The process of claim 90, wherein the particulate has a particle size in the range of from about 0.2 μm to about 1 μm and a mean particle size of about 0.3 μm to about 0.5 μm.

92. The process of claim 70, wherein the at least one electrically conductive material further comprises a metal.

93. The process of claim 92, wherein the metal is selected from the group consisting of nickel, gold, platinum, cobalt, chromium, copper, indium, aluminum, titanium, zirconium, iron, iridium, osmium, rhenium, ruthenium, rhodium, palladium, manganese, vanadium, alloys of such metals, salts of such metals, and mixtures thereof.

94. The process of claim 70, wherein the at least one inherently conductive polymer is doped with at least one dopant, which at least one dopant is at least one acid.

95. The process of claim 94, wherein the at least one acid is selected from the group consisting of HCl, nitric acid, phosphoric acid, phosphorous acid, phosphonous acids, phosphonic acids, phosphinous acids, phosphinic acids, carboxylic acids, organic sulfonic acids and ferric chloride.

96. The process of claim 94, wherein the at least one acid is HCl, phosphoric acid and/or dodecylbenzenephosphonic acid.

97. The process of claim 70, wherein the mixture in step (1) further comprises a binder in about 0.03% to about 2.5% by weight of the mixture.

98. The process of claim 70, wherein step (1) is performed by dispersing a composite comprising polyaniline and graphite flakes in the liquid medium to form the mixture, wherein the liquid medium comprises alcohol and xylene, wherein the alcohol is selected from methanol, ethanol, isopropanol and propanol; and step (2) is performed by providing a foam as the porous material.

99. The process of claim 98, wherein the weight ratio of the alcohol and xylene in the mixture of step (1) ranges from about 6:1 to about 10:1.

100. The process of claim 70, wherein the liquid medium in step (1) comprises at least one water-insoluble organic solvent.

101. The process of claim 100, wherein the at least one water-insoluble organic solvent is n-heptane.

102. The process of claim 70, wherein the liquid medium in step (1) comprises water and at least one water-soluble organic solvent.

103. The process of claim 102, wherein the at least one water-insoluble organic solvent is xylene.

104. The process of claim 103, wherein the weight ratio of water and xylene in the mixture ranges from about 6:1 to about 10:1.

105. The process of claim 104, wherein the weight ratio of water and xylene in the mixture is about 9:1.

106. A process for preparing the gas diffusion layer of claim 1, comprising the following steps:
(1) providing a porous material comprising a solid matrix, interconnected pores or interstices therethrough, at least one external surface and internal surfaces;
(2)(a)(i) applying a mixture comprising a liquid medium and at least one monomer of at least one inherently conductive polymer to at least one portion of the at least one external surface of the porous material; and
(2)(a)(ii) applying an activating substance to the at least one portion of the at least one external surface of the porous material to allow the at least one monomer to polymerize in situ in order to form the at least one inherently conductive polymer on the at least one portion of the at least one external surface of the porous material; or
(2)(b)(i) applying an activating substance to at least one portion of the at least one external surface of the porous material; and
(2)(b)(ii) applying a mixture comprising a liquid medium and at least one monomer of at least one inherently conductive polymer to the at least one portion of the at least one external surface of the porous material to allow the at least one monomer to polymerize in situ in order to form the at least one inherently conductive polymer on the at least one portion of the at least one external surface of the porous material; and
(3) removing any liquid medium unreacted monomer and activating substance from the porous material to form the gas diffusion layer, wherein the liquid medium comprises (a) water, (b) at least one water-soluble organic solvent, (c) at least one water-insoluble organic solvent, (d) at least one water-soluble organic solvent and at least one water-insoluble organic solvent, (e) at least one water-soluble organic solvent and water, or (f) at least one water-insoluble organic solvent and water.

107. The process of claim 106, wherein the at least one monomer comprises aniline, the liquid medium comprises water, and the activating substance is an oxidant.

108. The process of claim 107, wherein the oxidant is persulfate ammonium.

109. The process of claim 106, wherein the mixture further comprises particulate carbon or a particulate metal.

110. The process of claim 106, wherein the mixture further comprises particulate electrically conductive carbon.

111. The process of claim 110, wherein the particulate electrically conductive carbon is selected from the group consisting of amorphous carbon particulates, graphite powder and graphite flakes.

112. The process of claim 106, wherein the mixture further comprises a particulate metal.

113. The process of claim 112, wherein the particulate metal is selected from nickel, gold, platinum, cobalt, chromium, copper, indium, aluminum, titanium, zirconium, iron, iridium, osmium, rhenium, ruthenium, rhodium, palladium, manganese, vanadium, alloys of such metals, salts of such metals, and mixtures thereof in the form of a powder or flakes.

114. The process of claim 106, further comprising pressing the gas diffusion layer resulting from step (3) at a temperature ranging from about 80° C. to about 200° C. for about 1 to 10 minutes.

115. The process of claim 106, further comprising pressing the gas diffusion layer resulting from step (3) at a temperature of about 130° C. for about 2 minutes.

116. The process of claim 70, further comprising pressing the gas diffusion layer resulting from step (4) at a temperature ranging from about 80° C. to about 200° C. for about 1 to 10 minutes.

117. The process of claim 70, further comprising pressing the gas diffusion layer resulting from step (4) at a temperature of about 130° C. for about 2 minutes.

118. The process of claim 106, wherein the mixture in step (2)(a)(i) or (2)(b)(ii) further comprises at least one dopant, wherein the at least one dopant is at least one acid.

119. The process of claim 118, wherein the at least one acid is selected from the group consisting of HCl, nitric acid, phosphoric acid, phosphorous acid, phosphonous acids, phosphonic acids, phosphinous acids, phosphinic acids, organic sulfonic acids, carboxylic acids and ferric chloride.

120. The process of claim 106, wherein the mixture in step (2)(a)(i) or (2)(b)(ii) further comprises HCl, phosphoric acid or dodecylbenzenephosphonic acid.

121. The process of claim 120, wherein the at least one inherently conductive polymer is polyaniline.

122. The process of claim 121, wherein the at least one acid is dodecylbenzenephosphonic acid.

123. The process of claim 119, wherein the at least one acid is ferric chloride and the at least one conductive polymer is polythiophene.

124. The process of claim 96, wherein the at least one inherently conductive polymer is polyaniline.

125. The process of claim 124, wherein the at least one acid is dodecylbenzenephosphonic acid.

126. The process of claim 96, wherein the at least one inherently conductive polymer is polythiophene and the at least one acid is ferric chloride.

127. The gas diffusion layer of claim 1, wherein the porous material comprises a polyether polyurethane foam with about 40 to about 90 pores per linear inch felted with a compression ratio of about 4 to about 8, the at least one inherently conductive polymer being polyaniline doped with dodecylbenzenephosphonic acid, and wherein the at least one electrically conductive material further comprises particulate graphite with a dry weight ratio of the particulate graphite and polyaniline ranging from about 60:40 to about 75:25.

128. The gas diffusion layer of claim 1, wherein the porous material comprises a porous polymeric material and has a longest dimension, the porous material can wick water by capillary action and the water can subsequently be released from the porous material, the porous material has a free rise wick height greater than at least one half of the longest dimension.
